(19) United States
(12) Patent Application Publication
(10) Pub. No.: US 2022/0037681 A1
(43) Pub. Date: Feb. 3, 2022

(54) METHOD FOR PRODUCING FUEL CELL

(71) Applicant: TOYOTA JIDOSHA KABUSHIKI KAISHA, Toyota-shi (JP)

(72) Inventors: Makoto ICHIKAWA, Nagoya-shi (JP); Naohiro MITANI, Okazaki-shi (JP); Makoto ADACHI, Toyota-shi (JP)

(21) Appl. No.: 17/389,455

(22) Filed: Jul. 30, 2021

(30) Foreign Application Priority Data
Aug. 3, 2020 (JP) 2020-131469

(51) Int. Cl. H01M 8/0273; H01M 8/0284; H01M 8/1004; H01M 4/88

(52) U.S. Cl. CPC H01M 8/0273; H01M 4/8807; H01M 8/1004; H01M 8/0284

(57) ABSTRACT

To provide a fuel cell production method configured to suppress the formation of a blister in a thermoplastic sheet. The production method is a method for producing a fuel cell, wherein the method comprises: a first attaching step, a disposing step and a second attaching step in which, after the disposing step, the membrane electrode assembly and the resin frame are attached via the thermoplastic sheet, and the membrane electrode assembly and the gas diffusion layer are attached via the thermoplastic sheet.

### TECHNICAL FIELD

The disclosure relates to a method for producing a fuel cell.

### BACKGROUND

A fuel cell (FC) is a power generation device that generates electrical energy by electrochemical reaction between hydrogen (H₂), which serves as fuel gas, and oxygen (O₂), which serves as oxidant gas, in a fuel cell stack (hereinafter, it may be simply referred to as “stack”) composed of stacked unit fuel cells (hereinafter may be referred to as cells). Hereinafter, fuel gas and oxidant gas may be collectively and simply referred to as “reaction gas” or “gas”. Also, both the unit cell and the fuel cell stack composed of the stacked unit cells may be referred to as “fuel cell”.

In general, the unit fuel cells are composed of a membrane electrode assembly (MEA) and, as needed, two separators sandwiching the membrane electrode assembly.

The membrane electrode assembly has such a structure, that a catalyst layer is formed on both surfaces of a solid polymer electrolyte membrane having proton (H⁺) conductivity (hereinafter, it may be simply referred to as “electrolyte membrane”). Also, the membrane electrode assembly generally has such a structure, that a gas diffusion layer is further formed on a surface opposite to the surface on which the electrolyte membranes of the catalyst layers are formed. Accordingly, the membrane electrode assembly may be referred to as “membrane electrode gas diffusion layer assembly” (MEGA).

In general, the separators have such a structure, that a groove is formed as a reaction gas flow path on a surface in contact with the gas diffusion layer. The separators function as a collector of generated electricity.

In the fuel electrode (anode) of the fuel cell, the hydrogen supplied from the gas flow path and the gas diffusion layer is protonated by the catalytic activity of the catalyst layer, and the protonated hydrogen goes to the oxidant electrode (cathode) through the electrolyte membrane. An electron is generated at the same time, and it passes through an external circuit, do work, and then goes to the cathode. The oxygen supplied to the cathode reacts with the proton and electron on the cathode, thereby generating water.

The generated water provides the electrolyte membrane with appropriate moisture. Redundant water penetrates the gas diffusion layer and then is discharged to the outside of the system.

There has been considerable research on a fuel cell which is installed and used in a fuel cell vehicle (hereinafter may be simply referred to as “vehicle”).

For example, Patent Literature 1 discloses a fuel cell capable of suppressing rupture of a membrane electrode assembly when thermally curing an adhesive layer that is positioned between a support frame and a gas diffusion layer.
Patent Literature 1: Japanese Patent Application Laid-Open (JP-A) No. 2019-109964

The technique described in Patent Literature 1 has the following possibility. When applying an adhesive, a defect is formed in the resulting adhesive layer due to insufficient adhesive application, and a thin layer part is formed in the resulting adhesive layer due to variation in the applied amount of the adhesive, etc. Accordingly, stress is concentrated in the defect, the thin layer part, etc., thereby tearing the electrolyte membrane. To avoid the possibility, there is a method for attaching a resin frame (support frame), a gas diffusion layer and a membrane electrode assembly using a thermoplastic sheet. In a conventional attaching step using a thermoplastic sheet, however, a resin frame and a thermoplastic sheet are attached to each other, and then a membrane electrode assembly and the gas diffusion layer are disposed on a thermoplastic sheet and attached. Accordingly, there is a problem in that it is difficult to process a gap between the resin frame and the gas diffusion layer, and a blister is likely to be formed in the thermoplastic sheet.

### SUMMARY

The disclosed embodiments were achieved in light of the above circumstances. An object of the disclosed embodiments is to provide a fuel cell production method configured to suppress the formation of the blister in a thermoplastic sheet.

In a first embodiment, there is provided a method for producing a fuel cell comprising a membrane electrode assembly, a gas diffusion layer attached onto one surface of the membrane electrode assembly, a resin frame attached onto one surface of the membrane electrode assembly so that it is spaced from and surrounds an outer periphery of the gas diffusion layer when viewed in plan view, and a thermoplastic sheet disposed between a stacking direction of the gas diffusion layer and the membrane electrode assembly, disposed between a stacking direction of the resin frame and the membrane electrode assembly, and disposed so that it fills a gap between an inner periphery of the resin frame and the outer periphery of the gas diffusion layer when viewed in plan view,

wherein the method comprises:

a first attaching step in which the thermoplastic sheet is disposed on and attached to a peripheral edge on one surface of the membrane electrode assembly,

a disposing step in which, after the first attaching step, the gas diffusion layer is disposed on a surface opposite to the surface to which the membrane electrode assembly is attached of the thermoplastic sheet so that the gas diffusion layer is disposed on a more inner side than an outer periphery of the membrane electrode assembly when the fuel cell is viewed in plan view, and the resin frame is disposed so that it is spaced from and surrounds the outer periphery of the gas diffusion layer, and

a second attaching step in which, after the disposing step, the membrane electrode assembly and the resin frame are attached via the thermoplastic sheet, and the membrane electrode assembly and the gas diffusion layer are attached via the thermoplastic sheet, and

wherein the membrane electrode assembly includes an electrolyte membrane and two electrode catalyst layers disposed on both surfaces of the electrolyte membrane.

In the first attaching step, the membrane electrode assembly and the thermoplastic sheet may be attached by at least one attaching method selected from the group consisting of hot pressing, ultrasonic waves and laser.

According to the disclosed embodiments, the thermoplastic sheet and the membrane electrode assembly are attached before the resin frame and the thermoplastic sheet are attached. Thereby, the gap between the resin frame and the gas diffusion layer can be easily processed, and the formation of the blister in the thermoplastic sheet can be suppressed.

### BRIEF DESCRIPTION OF THE DRAWINGS

In the accompanying drawings,

FIG. 1 is a view showing an example of a conventional fuel cell production method;

FIG. 2 is a partial cross-sectional view of an example of the fuel cell obtained by the conventional production method;

FIG. 3 is a view showing an example of the fuel cell production method of the disclosed embodiments; and

FIG. 4 is a partial cross-sectional view of an example of the fuel cell obtained by the production method of the disclosed embodiments.

### DETAILED DESCRIPTION

The fuel cell production method of the disclosed embodiments is a method for producing a fuel cell comprising a membrane electrode assembly, a gas diffusion layer attached onto one surface of the membrane electrode assembly, a resin frame attached onto one surface of the membrane electrode assembly so that it is spaced from and surrounds an outer periphery of the gas diffusion layer when viewed in plan view, and a thermoplastic sheet disposed between a stacking direction of the gas diffusion layer and the membrane electrode assembly, disposed between a stacking direction of the resin frame and the membrane electrode assembly, and disposed so that it fills a gap between an inner periphery of the resin frame and the outer periphery of the gas diffusion layer when viewed in plan view,

wherein the method comprises:

a first attaching step in which the thermoplastic sheet is disposed on and attached to a peripheral edge on one surface of the membrane electrode assembly,

a disposing step in which, after the first attaching step, the gas diffusion layer is disposed on a surface opposite to the surface to which the membrane electrode assembly is attached of the thermoplastic sheet so that the gas diffusion layer is disposed on a more inner side than an outer periphery of the membrane electrode assembly when the fuel cell is viewed in plan view, and the resin frame is disposed so that it is spaced from and surrounds the outer periphery of the gas diffusion layer, and

a second attaching step in which, after the disposing step, the membrane electrode assembly and the resin frame are attached via the thermoplastic sheet, and the membrane electrode assembly and the gas diffusion layer are attached via the thermoplastic sheet, and

wherein the membrane electrode assembly includes an electrolyte membrane and two electrode catalyst layers disposed on both surfaces of the electrolyte membrane.

In the disclosed embodiments, the term “membrane electrode assembly” (MEA) means one having a structure such that electrode catalyst layers are formed on both surfaces of an electrolyte membrane.

Also in the disclosed embodiments, the term “membrane-electrode-gas diffusion layer assembly” (MEGA) means one having a structure such that a gas diffusion layer is formed on at least one surface of a membrane electrode assembly.

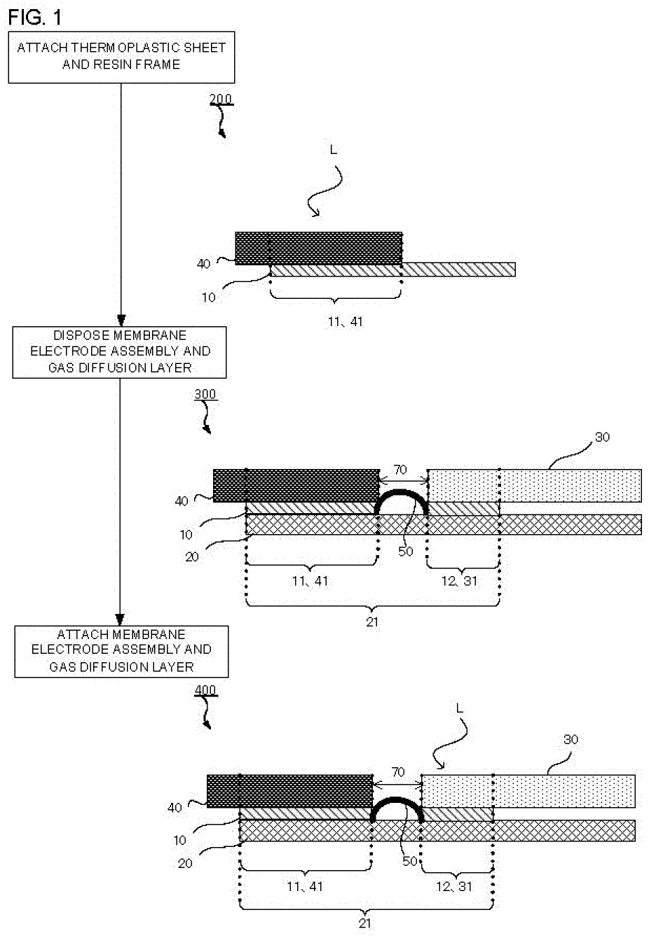

FIG. 1 is a view showing an example of a conventional fuel cell production method. FIG. 1 shows examples of schematic cross-sectional views of a thermoplastic sheet-resin frame assembly 200, a MEGA-thermoplastic sheet-resin frame stack 300 and a MEGA-thermoplastic sheet-resin frame assembly 400.

In the conventional fuel cell production method as shown in FIG. 1, first, a resin frame 40 is disposed on one surface of a frame-shaped thermoplastic sheet 10 so that an outer peripheral edge 11 of the thermoplastic sheet 10 is aligned with an inner peripheral edge 41 of the resin frame 40. Then, they are attached by laser L or the like, thereby obtaining the thermoplastic sheet-resin frame assembly 200.

Next, on the surface opposite to the surface to which the resin frame 40 is attached of the thermoplastic sheet 10, a membrane electrode assembly 20 is disposed so that the thermoplastic sheet 10 is aligned with a peripheral edge 21 of the membrane electrode assembly 20. On the surface to which the resin frame 40 is attached of the thermoplastic sheet 10, a gap 70 is formed between the resin frame 40 and a gas diffusion layer 30, and the gas diffusion layer 30 is disposed so that an inner peripheral edge 12 of the thermoplastic sheet 10 is aligned with an outer peripheral edge 31 of the gas diffusion layer 30, thereby obtaining the MEGA-thermoplastic sheet-resin frame stack 300.

Then, the membrane electrode assembly 20 and the gas diffusion layer 30 are attached via the thermoplastic sheet 10 by the laser L or the like, thereby obtaining the MEGA-thermoplastic sheet-resin frame assembly 400. By the production method shown in FIG. 1, a blister 50 of the thermoplastic sheet 10 is likely to be formed in the region of the gap 70 between the resin frame 40 and the gas diffusion layer 30.

The MEGA-thermoplastic sheet-resin frame assembly 400 may be used as it is as a conventional fuel cell, or the MEGA-thermoplastic sheet-resin frame assembly 400 may be sandwiched by two separators and then used as a conventional fuel cell.

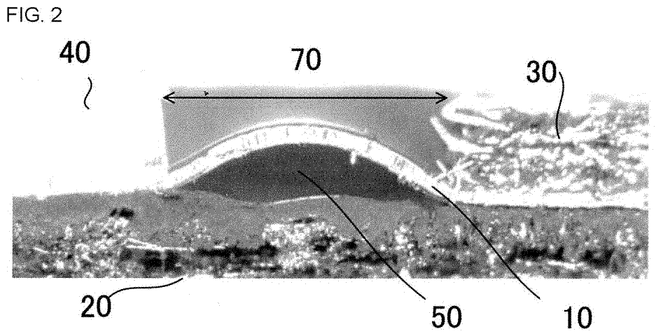

FIG. 2 is a partial cross-sectional view of an example of the fuel cell obtained by the conventional production method.

As shown in FIG. 2, the blister 50 of the thermoplastic sheet 10 is formed in the region of the gap 70 between the resin frame 40 and gas diffusion layer 30 attached onto one surface of the membrane electrode assembly 20 via the thermoplastic sheet 10.

In the conventional fuel cell production step using the thermoplastic sheet as shown in FIG. 1, after the resin frame and the thermoplastic sheet are attached, the membrane electrode assembly and the gas diffusion layer are disposed on and attached to the thermoplastic sheet.

However, the resin frame and the gas diffusion layer serve as a barrier and pose the following problem: it is difficult to process the gap between the resin frame and the gas diffusion layer, and the blister as shown in FIG. 2 is likely to be formed in the thermoplastic sheet.

As a result, there is the following problem: the membrane electrode assembly cannot be protected, and during the power generation of the fuel cell, stress is concentrated in the membrane electrode assembly to create a tear or the like in the electrolyte membrane, and thereby the durability of the fuel cell is decreased. As the case where stress is concentrated in the membrane electrode assembly, examples include, but are not limited to, a case where the fuel cell is subjected to a temperature change and the resin frame is subjected to expansion and contraction, a case where the electrolyte membrane is repeatedly subjected to swelling and drying during the power generation of the fuel cell, etc., and a case where liquid water inside or outside the electrolyte membrane is frozen.

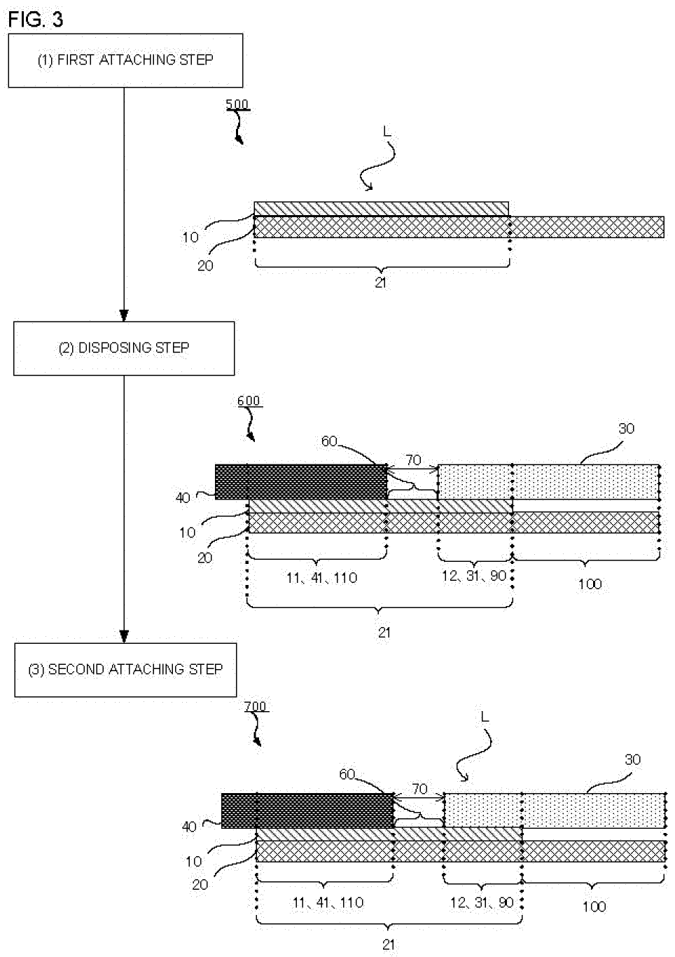

FIG. 3 is a view showing an example of the fuel cell production method of the disclosed embodiments. FIG. 3 shows examples of schematic cross-sectional views of a MEA-thermoplastic sheet assembly 500, a MEGA-thermoplastic sheet-resin frame stack 600 and a MEGA-thermoplastic sheet-resin frame assembly 700.

As shown in FIG. 3, in the fuel cell production method of the disclosed embodiments, first, the membrane electrode assembly 20 is disposed on one surface of the frame-shaped thermoplastic sheet 10 so that the thermoplastic sheet 10 is aligned with the peripheral edge 21 of the membrane electrode assembly 20. Then, the thermoplastic sheet 10 and the membrane electrode assembly 20 are attached by the laser L or the like, thereby obtaining the MEA-thermoplastic sheet assembly 500 (the first attaching step).

Next, on the surface opposite to the surface to which the membrane electrode assembly 20 is attached of the thermoplastic sheet 10, the gas diffusion layer 30 is disposed so that the inner peripheral edge 12 of the thermoplastic sheet 10 is aligned with the outer peripheral edge 31 of the gas diffusion layer 30. Also, the gap 70 is formed between the gas diffusion layer 30 and the resin frame 40, and the resin frame 40 is disposed so that the outer peripheral edge 11 of the thermoplastic sheet 10 is aligned with the inner peripheral edge 41 of the resin frame 40, thereby obtaining the MEGA-thermoplastic sheet-resin frame stack 600 (the disposing step). Accordingly, as shown by the cross-section of the MEGA-thermoplastic sheet-resin frame stack, a region where the inner peripheral edge 12 of the thermoplastic sheet 10 and the outer peripheral edge 31 of the gas diffusion layer 30 are aligned with each other in the stacking direction, that is, an aligned region 90 where the thermoplastic sheet 10 and the gas diffusion layer 30 are aligned in the stacking direction, is formed. Also, a region where the gas diffusion layer 30 on one surface of the thermoplastic sheet 10 is not aligned with the thermoplastic sheet 10 in the stacking direction, that is, a non-aligned region 100 where the thermoplastic sheet 10 and the gas diffusion layer 30 are not aligned in the stacking direction, is formed. Also, a region where a part of the peripheral edge 21 of the membrane electrode assembly 20, the outer peripheral edge 11 of the thermoplastic sheet 10, and the inner peripheral edge 41 of the resin frame 40 are aligned in the stacking direction, that is, an aligned region 110 where the thermoplastic sheet 10, the membrane electrode assembly 20 and the resin frame 40 are aligned in the stacking direction, is formed.

Then, the membrane electrode assembly 20 and the gas diffusion layer 30 are attached via the thermoplastic sheet 10 by the laser L or the like, and the membrane electrode assembly 20 and the resin frame 40 are attached via the thermoplastic sheet 10 by the laser L or the like, thereby obtaining the MEGA-thermoplastic sheet-resin frame assembly 700 (the second attaching step). By the production method shown in FIG. 3, an adhering part 60 where the thermoplastic sheet 10 and the membrane electrode assembly 20 adhere to each other in the stacking direction, is formed.

The MEGA-thermoplastic sheet-resin frame assembly 700 may be used as it is as the fuel cell of the disclosed embodiments, or the MEGA-thermoplastic sheet-resin frame assembly 700 may be sandwiched by two separators and then used as the fuel cell of the disclosed embodiments.

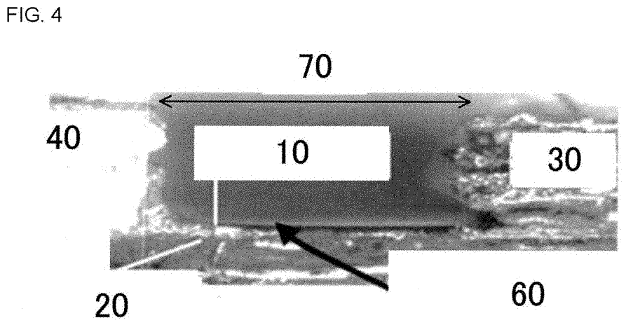

FIG. 4 is a partial cross-sectional view of an example of the fuel cell obtained by the production method of the disclosed embodiments.

As shown in FIG. 4, the adhering part 60 where the thermoplastic sheet 10 and the membrane electrode assembly 20 adhere to each other in the stacking direction, is formed in the region of the gap 70 between the resin frame 40 and gas diffusion layer 30 attached onto one surface of the membrane electrode assembly 20 via the thermoplastic sheet 10.

According to the disclosed embodiments, the thermoplastic sheet and the membrane electrode assembly are attached before the resin frame and the thermoplastic sheet are attached. Thereby, the gap between the resin frame and the gas diffusion layer can be easily processed, and the formation of the blister in the thermoplastic sheet can be suppressed.

As a result, the whole membrane electrode assembly including the gap between the resin frame and the gas diffusion layer, can be protected; the concentration of stress in the membrane electrode assembly during the power generation of the fuel cell, can be suppressed; and the durability of the fuel cell can be increased.

The membrane electrode assembly includes a part which is protected by the resin frame or the gas diffusion layer and prevented from a change in form. Unlike the part, the gap between the resin frame and gas diffusion layer on one surface of the membrane electrode assembly, is more likely to be subjected to stress concentration. However, the durability of the whole fuel cell is further increased by suppressing the generation of the blister of the thermoplastic sheet in the gap.

The fuel cell production method of the disclosed embodiments includes at least (1) the first attaching step, (2) the disposing step and (3) the second attaching step.

### (1) First Attaching Step

The first attaching step is a step in which the thermoplastic sheet is disposed on and attached to the peripheral edge on one surface of the membrane electrode assembly. The MEA-thermoplastic sheet assembly is obtained by the first attaching step.

In the disclosed embodiments, the term “on one surface of the membrane electrode assembly” includes at least a region aligned with the membrane electrode assembly in the stacking direction. Also, it may include a region not aligned with the membrane electrode assembly in the stacking direction.

In the first attaching step, the membrane electrode assembly and the thermoplastic sheet may be attached by at least one attaching method selected from the group consisting of hot pressing, ultrasonic waves and laser.

The hot pressing may be hot pressing using a mold, or it may be hot pressing using a hot pressing roller. The temperature of the hot pressing is not particularly limited. It may be appropriately determined depending on the type of thermoplastic resin used.

As the ultrasonic waves, a conventionally-known ultrasonic generator may be used. The output of the ultrasonic waves is not particularly limited. It may be determined depending on the type of the thermoplastic resin used.

As the laser, a conventionally-known laser irradiation device may be used. The output of the laser is not particularly limited. It may be determined depending on the type of the thermoplastic resin used.

As the membrane electrode assembly used in the first attaching step, a membrane electrode assembly produced by a conventionally-known method may be prepared.

The thermoplastic sheet is disposed on the peripheral edge on one surface of the membrane electrode assembly. Accordingly, the membrane electrode assembly includes the aligned region where the membrane electrode assembly is aligned with the thermoplastic sheet in the stacking direction of the thermoplastic sheet and the membrane electrode assembly. Also, the membrane electrode assembly includes the non-aligned region where the membrane electrode assembly is not aligned with the thermoplastic sheet in the stacking direction of the thermoplastic sheet and the membrane electrode assembly.

The shape of the thermoplastic sheet disposed by the first attaching step may be a hollow frame shape or the like when the thermoplastic sheet is viewed in plan view.

### (2) Disposing Step

The disposing step is a step in which, after the first attaching step, the gas diffusion layer is disposed on the surface opposite to the surface to which the membrane electrode assembly is attached of the thermoplastic sheet so that the gas diffusion layer is disposed on the more inner side than the outer periphery of the membrane electrode assembly when the fuel cell is viewed in plan view, and the resin frame is disposed so that it is spaced from and surrounds the outer periphery of the gas diffusion layer. The MEGA-thermoplastic sheet-resin frame stack is obtained by the disposing step.

In the disclosed embodiments, the term “on one surface of the thermoplastic sheet” includes at least a region aligned with the thermoplastic sheet in the stacking direction. Also, it may include a region not aligned with the thermoplastic sheet in the stacking direction.

In the disposing step, the position where the gas diffusion layer is disposed is not particularly limited, as long as it is on one surface of the thermoplastic sheet and on the more inner side than the outer periphery of the membrane electrode assembly when the fuel cell is viewed in plan view.

That is, the gas diffusion layer may be disposed on one surface of the thermoplastic sheet so that it includes the aligned region where the gas diffusion layer is aligned with the thermoplastic sheet in the stacking direction of the thermoplastic sheet and the gas diffusion layer, and the non-aligned region where the gas diffusion layer is not aligned with the thermoplastic sheet and is aligned with the membrane electrode assembly in the stacking direction of the thermoplastic sheet and the gas diffusion layer.

The area of the gas diffusion layer disposed in the disposing step is smaller than the area of the membrane electrode assembly when the fuel cell is viewed in plan view.

The resin frame may be disposed so that it is spaced from and surrounds the outer periphery of the gas diffusion layer when the fuel cell is viewed in plan view. That is, the gas diffusion layer may be disposed in the more inner region than the inner periphery of the resin frame when the fuel cell is viewed in plan view.

Also, the resin frame may be disposed on one surface of the thermoplastic sheet and on the more outer side than the outer periphery of the membrane electrode assembly when the fuel cell is viewed in plan view. That is, the resin frame may be disposed on one surface of the thermoplastic sheet so that it includes the aligned region where the resin frame is aligned with the thermoplastic sheet in the stacking direction of the thermoplastic sheet and the resin frame, and the non-aligned region where the resin frame is not aligned with the thermoplastic sheet in the stacking direction of the thermoplastic sheet and the resin frame.

The width of the gap between the inner periphery of the resin frame and the outer periphery of the gas diffusion layer is not particularly limited. For example, it may be 200 μm or more and less than 1 mm.

### (3) Second Attaching Step

The second attaching step is a step in which, after the disposing step, the membrane electrode assembly and the resin frame are attached via the thermoplastic sheet, and the membrane electrode assembly and the gas diffusion layer are attached via the thermoplastic sheet. The MEGA-thermoplastic sheet-resin frame assembly is obtained by the second attaching step.

In the second attaching step, no particular limitation is imposed on the method for attaching the membrane electrode assembly and the resin frame via the thermoplastic sheet and the method for attaching the membrane electrode assembly and the gas diffusion layer via the thermoplastic sheet. For example, the attaching method exemplified above in the first attaching step may be employed.

After the second attaching step, the obtained MEGA-thermoplastic sheet-resin frame assembly may be used as it is as the fuel cell of the disclosed embodiments. As needed, the MEGA-thermoplastic sheet-resin frame assembly may be sandwiched by two separators via the resin frame and then used as the fuel cell of the disclosed embodiments.

The fuel cell obtained by the production method of the disclosed embodiments, comprises a membrane electrode assembly, a gas diffusion layer attached onto one surface of the membrane electrode assembly, a resin frame attached onto one surface of the membrane electrode assembly so that it is spaced from and surrounds an outer periphery of the gas diffusion layer when viewed in plan view, and a thermoplastic sheet disposed between a stacking direction of the gas diffusion layer and the membrane electrode assembly, disposed between a stacking direction of the resin frame and the membrane electrode assembly, and disposed so that it fills a gap between an inner periphery of the resin frame and the outer periphery of the gas diffusion layer when viewed in plan view. As needed, the fuel cell obtained by the production method of the disclosed embodiments includes two separators sandwiching the MEGA-thermoplastic sheet-resin frame assembly via the resin frame, etc.

The membrane electrode assembly includes an electrolyte membrane and two electrode catalyst layers disposed on both surfaces of the electrolyte membrane.

The membrane electrode assembly may include the peripheral edge aligned with the thermoplastic sheet in the stacking direction.

The electrolyte membrane and the two electrode catalyst layers may have almost the same size or different sizes. They may be stacked so that their outer peripheries are almost aligned with each other, or they may be stacked so that their outer peripheries are not aligned with each other.

The two electrode catalyst layers are an oxidant electrode catalyst layer and a fuel electrode catalyst layer.

The oxidant electrode catalyst layer and the fuel electrode catalyst layer may contain a catalyst metal for accelerating an electrochemical reaction, a proton-conducting electrolyte, or electron-conducting carbon particles, for example.

As the catalyst metal, for example, platinum (Pt) or an alloy of Pt and another metal (such as Pt alloy mixed with cobalt, nickel or the like) may be used.

The electrolyte may be fluorine resin or the like. As the fluorine resin, for example, a Nafion solution may be used.

The catalyst metal is supported on carbon particles. In each catalyst layer, the carbon particles supporting the catalyst metal (i.e., catalyst particles) and the electrolyte may be mixed.

As the carbon particles for supporting the catalyst metal (i.e., supporting carbon particles), for example, water repellent carbon particles obtained by enhancing the water repellency of commercially-available carbon particles (carbon powder) by heating, may be used.

The electrolyte membrane may be a solid polymer electrolyte membrane. As the solid polymer electrolyte membrane, examples include, but are not limited to, a hydrocarbon electrolyte membrane and a fluorine electrolyte membrane such as a moisture-containing, thin perfluorosulfonic acid membrane. The electrolyte membrane may be a Nafion membrane (manufactured by DuPont), for example.

The gas diffusion layer may be attached onto one surface of the membrane electrode assembly as a first gas diffusion layer. As long as the gas diffusion layer is attached onto one surface of the membrane electrode assembly as the first gas diffusion layer, another gas diffusion layer may be attached onto the other surface of the membrane electrode assembly as a second gas diffusion layer.

The gas diffusion layer attached onto one surface of the membrane electrode assembly (the first gas diffusion layer) is smaller than the membrane electrode assembly in horizontal and vertical size, and the whole outer periphery of the gas diffusion layer is spaced from the outer periphery of the membrane electrode assembly and disposed on the inner side.

The gas diffusion layer attached onto one surface of the membrane electrode assembly (the first gas diffusion layer) may include the outer peripheral edge aligned with the inner peripheral edge of the thermoplastic sheet in the stacking direction.

The gas diffusion layer attached onto the other surface of the membrane electrode assembly (the second gas diffusion layer) and the membrane electrode assembly may have almost the same size. They may be stacked so that their outer peripheries are almost aligned with each other.

That is, the area of the gas diffusion layer attached onto one surface of the membrane electrode assembly (the first gas diffusion layer) is smaller than the area of the membrane electrode assembly when the fuel cell is viewed in plan view. The area of the gas diffusion layer attached onto the other surface of the membrane electrode assembly (the second gas diffusion layer) is not particularly limited. It may be smaller than, the same as, or larger than the area of the membrane electrode assembly, or the gas diffusion layer may have a size that fits in the separators.

The gas diffusion layer attached onto one surface of the membrane electrode assembly (the first gas diffusion layer) may be a cathode-side gas diffusion layer or an anode-side gas diffusion layer. When the gas diffusion layer attached onto one surface of the membrane electrode assembly (the first gas diffusion layer) is the cathode-side gas diffusion layer, the gas diffusion layer attached onto the other surface of the membrane electrode assembly (the second gas diffusion layer) is the anode-side gas diffusion layer. On the other hand, when the gas diffusion layer attached onto one surface of the membrane electrode assembly (the first gas diffusion layer) is the anode-side gas diffusion layer, the gas diffusion layer attached onto the other surface of the membrane electrode assembly (the second gas diffusion layer) is the cathode-side gas diffusion layer.

The gas diffusion layer may be a gas-permeable, electroconductive member or the like.

As the electroconductive member, examples include, but are not limited to, a porous carbon material such as carbon cloth and carbon paper, and a porous metal material such as metal mesh and foam metal.

The resin frame is attached onto one surface of the membrane electrode assembly so that it is spaced from and surrounds the outer periphery of the gas diffusion layer when the fuel cell is viewed in plan view.

The resin frame is a frame-shaped resin component disposed around (in the outer periphery of) the membrane electrode assembly when the fuel cell is viewed in plan view.

The resin frame includes an opening at the center. The opening is a MEGA holding region, that is, a MEA holding region.

Also, the resin frame is a resin component for preventing a cross leak, an electrical short circuit between the catalyst layers of the membrane electrode assembly, etc.

The resin frame may include the inner peripheral edge that is aligned with the outer peripheral edge of the thermoplastic sheet in the stacking direction.

The resin frame may extend in parallel with the membrane electrode assembly, at an offset position from the plane of the membrane electrode assembly.

The resin frame may be disposed between the stacking direction of the two separators (the anode-side and cathode-side separators) which may be included in the fuel cell.

The resin frame may include a reaction gas supply hole, a reaction gas discharge hole, a refrigerant supply hole and a refrigerant discharge hole, which are aligned and disposed to communicate with the reaction gas supply hole, reaction gas discharge hole, refrigerant supply hole and refrigerant discharge hole of the separators, respectively.

The resin frame may include a frame-shaped resin core layer and two frame-shaped adhesive layers disposed on both surfaces of the core layer, that is, the first adhesive layer and the second adhesive layer.

As with the core layer, the first adhesive layer and the second adhesive layer may be disposed in a frame-shaped manner on both surfaces of the core layer.

The core layer may be formed from such a material, that the structure is not changed at the temperatures of hot pressing in the step of producing the fuel cell. As the material for the core layer, examples include, but are not limited to, polyethylene naphthalate (PEN), polyethersulfone (PES) and polyethylene terephthalate (PET).

To attach the core layer, the anode-side separator and the cathode-side separator and ensure sealing properties, the first and second adhesive layers may have the following properties: high adhesion to other substances, capability of softening at the hot pressing temperatures, and lower viscosity and melting point than the core layer. In particular, the first and second adhesive layers may be thermoplastic resin such as polyester resin and modified olefin resin, or it may be thermosetting resin (modified epoxy resin). The resin forming the first adhesive layer may be the same as or different from the resin forming the second adhesive layer. As a result of disposing the adhesive layers on both surfaces of the core layer, the resin frame and the two separators can be easily attached by hot pressing.

The first adhesive layer and second adhesive layer of the resin frame may be disposed only in a part which is attached to the anode-side separator and a part which is attached to the cathode-side separator, respectively. The first adhesive layer disposed on one surface of the core layer may be attached to the cathode-side separator. The second adhesive layer disposed on the other surface of the core layer may be attached to the anode-side separator. Then, the resin frame may be sandwiched by the pair of separators.

The thermoplastic sheet is disposed between the stacking direction of the gas diffusion layer and the membrane electrode assembly, disposed between the stacking direction of the resin frame and the membrane electrode assembly, and disposed so that it fills the gap between the inner periphery of the resin frame and the outer periphery of the gas diffusion layer when the fuel cell is viewed in plan view.

The thermoplastic sheet may be disposed between the stacking direction of the resin frame and the membrane electrode assembly and attach them. More specifically, the thermoplastic sheet may be disposed between the inner peripheral edge of the resin frame and the peripheral edge (the peripheral edge region) of the membrane electrode assembly and attach them.

The thermoplastic sheet may be disposed so that the outer peripheral edge of the thermoplastic sheet is aligned with the inner peripheral edge of the resin frame in the stacking direction of the resin frame and the gas diffusion layer, and the inner peripheral edge of the thermoplastic sheet is aligned with the outer peripheral edge of the gas diffusion layer in the stacking direction of the resin frame and the gas diffusion layer.

The area of the region where the outer peripheral edge of the thermoplastic sheet is aligned with the inner peripheral edge of the resin frame, and the area of the region where the inner peripheral edge of the thermoplastic sheet is aligned with the outer peripheral edge of the gas diffusion layer, are not particularly limited. They may be determined depending on the accuracy of alignment in the fuel cell production so that the thermoplastic sheet fills the gap.

The shape of the thermoplastic sheet may be a frame shape, for example.

The thermoplastic sheet may include the outer peripheral edge aligned with the inner peripheral edge of the resin frame in the stacking direction.

The thermoplastic sheet may include the inner peripheral edge aligned with the outer peripheral edge of the gas diffusion layer in the stacking direction.

The thermoplastic resin used to form the thermoplastic sheet is not particularly limited. For example, it may be a thermoplastic resin having a melting point of 200° C. or less, or it may be a thermoplastic adhesive resin having adhesive properties. As the thermoplastic resin, examples include, but are not limited to, polyethylene, polypropylene and polyisobutylene (PIB).

From the viewpoint of securing the function of reinforcing the gap between the gas diffusion layer and the resin frame, the thickness of the thermoplastic sheet may be 1 μm or more, 10 μm or more, or 30 μm or more, for example. The thickness in the stacking direction is increased by disposing the thermoplastic sheet, resulting in a level difference. From the viewpoint of suppressing the level difference, the thickness of the thermoplastic sheet may be 300 μm or less, 100 μm or less, 70 μm or less, or 50 μm or less. From the viewpoint of chemically protecting the MEA, the thermoplastic sheet may be a dense sheet substantially having no pores. The dense sheet is allowed to have a pore of 10 μm or less in diameter, as long as the influence of a chemical substance introduced from the outside falls within an acceptable range.

The separators include a reaction gas flow path for flowing the reaction gas in the planar direction (horizontal direction) of the separators, the reaction gas supply hole for distributing the reaction gas in the stacking direction of the unit cells, and the reaction gas discharge hole for distributing the reaction gas in the stacking direction of the unit cells.

The reaction gas may be fuel gas or oxidant gas.

As the reaction gas supply hole, examples include, but are not limited to, a fuel gas supply hole and an oxidant gas supply hole.

As the reaction gas discharge hole, example include, but are not limited to, a fuel gas discharge hole and an oxidant gas discharge hole.

The separators may have a refrigerant supply hole and a refrigerant discharge hole, which are holes for distributing a refrigerant in the stacking direction of the unit cells.

The separators may have the reaction gas flow path on a surface in contact with the gas diffusion layer. Also, on an opposite surface to the surface in contact with the gas diffusion layer, the separators may have a refrigerant flow path for keeping the fuel cell temperature at a constant level.

The separators may be a gas-impermeable, electroconductive member, etc. As the electroconductive member, examples include, but are not limited to, gas-impermeable dense carbon obtained by carbon densification, and a metal plate obtained by press molding. The separators may have a current collection function.

### REFERENCE SIGNS LIST

10. Thermoplastic sheet
11. Outer peripheral edge of the thermoplastic sheet
12. Inner peripheral edge of the thermoplastic sheet
20. Membrane electrode assembly
21. Peripheral edge of the membrane electrode assembly
30. Gas diffusion layer
31. Outer peripheral edge of the gas diffusion layer
40. Resin frame
41. Inner peripheral edge of the resin frame
50. Blister
60. Adhering part
70. Gap
90. Aligned region where the thermoplastic sheet and the gas diffusion layer are aligned in the stacking direction
100. Non-aligned region where the thermoplastic sheet and the gas diffusion layer are not aligned in the stacking direction.
110. Aligned region where the thermoplastic sheet, the membrane electrode assembly and the resin frame are aligned in the stacking direction
200. Thermoplastic sheet-resin frame assembly
300. MEGA-thermoplastic sheet-resin frame stack
400. MEGA-thermoplastic sheet-resin frame assembly
500. MEA-thermoplastic sheet assembly
600. MEGA-thermoplastic sheet-resin frame stack
700. MEGA-thermoplastic sheet-resin frame assembly
L. Laser

1. A method for producing a fuel cell comprising a membrane electrode assembly, a gas diffusion layer attached onto one surface of the membrane electrode assembly, a resin frame attached onto one surface of the membrane electrode assembly so that it is spaced from and surrounds an outer periphery of the gas diffusion layer when viewed in plan view, and a thermoplastic sheet disposed between a stacking direction of the gas diffusion layer and the membrane electrode assembly, disposed between a stacking direction of the resin frame and the membrane electrode assembly, and disposed so that it fills a gap between an inner periphery of the resin frame and the outer periphery of the gas diffusion layer when viewed in plan view,
wherein the method comprises:
a first attaching step in which the thermoplastic sheet is disposed on and attached to a peripheral edge on one surface of the membrane electrode assembly,
a disposing step in which, after the first attaching step, the gas diffusion layer is disposed on a surface opposite to the surface to which the membrane electrode assembly is attached of the thermoplastic sheet so that the gas diffusion layer is disposed on a more inner side than an outer periphery of the membrane electrode assembly when the fuel cell is viewed in plan view, and the resin frame is disposed so that it is spaced from and surrounds the outer periphery of the gas diffusion layer, and
a second attaching step in which, after the disposing step, the membrane electrode assembly and the resin frame are attached via the thermoplastic sheet, and the membrane electrode assembly and the gas diffusion layer are attached via the thermoplastic sheet, and
wherein the membrane electrode assembly includes an electrolyte membrane and two electrode catalyst layers disposed on both surfaces of the electrolyte membrane.

2. The method for producing the fuel cell according to claim 1, wherein, in the first attaching step, the membrane electrode assembly and the thermoplastic sheet are attached by at least one attaching method selected from the group consisting of hot pressing, ultrasonic waves and laser.
